(19) United States
(12) Patent Application Publication
(10) Pub. No.: US 2014/0350278 A1
(43) Pub. Date: Nov. 27, 2014

(54) Polymerizable Hybrid Polysiloxanes and Preparation

(71) Applicants: Dow Corning Corporation, Midland, MI (US); Dow Corning Taiwan Inc., Taipei (TW)

(72) Inventors: Mark David Fisher, Midland, MI (US); Roger A. Gibas, Bay City, MI (US); Laurie N. Kroupa, Delaware, OH (US); Kathryn E. Messner, Midland, MI (US); Do-Lung Pan, Taoyuan Hsien (TW); Randall G. Schmidt, Midland, MI (US); Christine A. Weber, Pinconning, MI (US); Shengqing Xu, Midland, MI (US)

(73) Assignee: Dow Corning Taiwan Inc., Taipei (TW)

(21) Appl. No.: 14/366,758

(22) PCT Filed: Dec. 18, 2012
(86) PCT No.: PCT/US2012/070390

§ 371 Date: Jun. 19, 2014

Related U.S. Application Data
(60) Provisional application No. 61/578,828, filed on Dec. 21, 2011.

(51) Int. Cl. C08G 77/46

(52) U.S. Cl. CPC C08G 77/46
USPC 556/446

(57) ABSTRACT

The present invention relates to a process of making a polymerizable hybrid polysiloxane or a polymerizable hybrid siloxane. The process includes reacting an organopolysiloxane or organosiloxane having an average of at least 3 silicon hydride (SiH) groups per molecule, a polyoxyethylene, and a catalyst. The process also optionally includes adding a stabilizer, a catalytic inhibitor, a solvent, and an unsaturated reactant selected from substituted and unsubstituted unsaturated organic compounds.

### FIELD OF THE INVENTION

The invention relates to novel hydrophilic silicones with silicon hydride functional groups and methods of their preparation. The novel hydrophilic silicones can be useful in preparing hydrophilic silicone gel adhesives and medical, personal care, house care, textile, electronics, coatings, energy storage, construction, oil production, surfactants, membranes for gas or liquid separation, and agriculture articles incorporating such materials.

### BACKGROUND OF THE INVENTION

Silicone gels, rubbers, and elastomers are the terms generally used to describe elastic materials prepared by the crosslinking of polyorganosiloxanes and organosiloxanes. Gels, elastomers, and rubbers are differentiated by the extent of crosslinking within the siloxane network, by hardness, and elasticity. These materials may be used in medical wound dressings to treat most types of wounds safely. Studies have shown that silicone adhesives can be removed without causing trauma to the wound or to the surrounding skin or patient. Since silicone is inert, biocompatible, and has good gas permeability, it does not interact chemically with the wound or have any effect upon the cells responsible for the healing process. However, its hydrophobic property results in poor wettability by body liquids and uncomfortable feeling. Silicone adhesives may be used for neonatal care, medical device attachment, wound care, skin therapy, scar management, and the like.

Polymerizable hybrid polysiloxanes and siloxanes are used as raw materials in preparation of silicone gel adhesives through their further reactions with other materials to form the silicone gels as skin adhesives, which have gentle adhesion to wound bed and surrounding skin without causing trauma following removal. They are useful in a variety of applications by virtue of their unique combination of properties, including hydrophilic properties endowed to the silicone materials. Generally speaking, the term “hydrophilic” refers to a material having a surface free energy that it is wettable by an aqueous medium. These hydrophilic silicone materials used as wound dressings for application to hemorrhagic living tissues would be expected to maintain a moist wound healing environment and breathable for moisture, to promote wound exudate absorption to prevent maceration, and also to enhance transportation of wound exudate through and into the silicone layer.

Processes to synthesize SiH terminated copolymers are generally known and disclosed, for instance, in U.S. Pat. No. 3,518,288. Although many polymerizable hybrid polysiloxanes are known, there nevertheless remains a need in the art for silicone resins having improved properties, preferably more than one improved property.

### SUMMARY OF THE INVENTION

The present disclosure relates to a process of making polymerizable hybrid polysiloxanes and siloxanes having one or more improved properties over those of known compositions.

The polymerizable hybrid polysiloxanes and siloxanes may be prepared by reacting (a) an organopolysiloxane having an average of at least 3 silicon hydride (SiH) groups per molecule, (b) a polyoxyethylene (PEO) with functional groups, and (c) a catalyst. The reaction may optionally include: (d) a stabilizer, (e) a catalytic inhibitor, (f) a solvent, and/or (g) an unsaturated reactant selected from substituted and unsubstituted unsaturated organic compounds.

The organopolysiloxane component (a) may be linear or cyclic. Linear organopolysiloxanes may be represented by the formulae (1) or (2)

R¹₃SiO(R¹₂SiO)_{d}(R¹HSiO)ₑSiR¹₃, (1)

R¹₂HSiO(R¹₂SiO)_{f}SiHR¹₂. (2)

Subscript “d” typically may have a value ranging from 0 to 2000. Subscript “e” may be 0 or a positive number. Alternatively, subscript “e” may have a value ranging from 3 to 200. Subscript “f” typically may have a value ranging from 0 to 500. Each R¹ is independently selected from aliphatically saturated organic groups.

Cyclic SiH-containing organopolysiloxanes, chemically are characterized by the —R^{y}SiH—O— repeating unit, for example, D₄^{RyH} contains 3 of these repeating units closed in a cycle and D₅^{RyH} and D₆^{RyH} respectively contain 5 and 6 of them. Where R^{y} is methyl, the cyclic SiH-containing organopolysiloxane D₄^{RyH}, D₅^{RyH}, and D₆^{RyH} can be signed as D₄^{H}, D₅^{H}, and D₆^{H}, respectively. In this invention, the cyclic SiH-containing organopolysiloxane ring with n members, Dₙ^{RyH}, may be represented by the general formula (3)

R^{y}HSiO_{n/n} (3)

Subscript “n” typically has a value equal or greater than 3. R^{y} typically is a monovalent organic group.

The organopolysiloxane or organosiloxane component (a) may include one or more terminal groups such as alkyl, aryl, alkoxy, or hydroxyl groups.

The polymerizable hybrid polysiloxanes and siloxanes may include an MQ, TD, MT, or MTD resin. The oxyethylene content in the polymerizable hybrid polysiloxanes and siloxanes may be from about 5 to about 95 percent by weight.

Additional aspects of the invention will be apparent to those of ordinary skill in the art in view of the detailed description of various embodiments, a brief description of which is provided below.

### DETAILED DESCRIPTION

This invention relates to polymerizable hybrid polysiloxanes and siloxanes, and more particularly, to polyoxyethylene-organopolysiloxane and polyoxyethylene-organosiloxane copolymers, hereafter “copolymers”. The copolymers may be used as cross-linkers having an average of at least 2 silicon-bonded hydrogen (SiH) atoms per molecule. The copolymers may also be functionalized with at least 2 silicon-bonded vinyl groups per molecule.

The copolymers may be prepared by mixing (a) an organopolysiloxane or organosiloxane having an average of at least 3 silicon hydride (SiH) groups per molecule, (b) a polyoxyethylene, and (c) a catalyst. The components may be added together mixed by any known techniques. The copolymers may also be prepared by optionally mixing components (a), (b), and (c) above with (d) a stabilizer, (e) a catalytic inhibitor, (f) a solvent, or (g) an unsaturated reactant selected from substituted and unsubstituted organic compounds.

The organopolysiloxane component (a) may also include terminal groups that may be further defined as alkyl or aryl groups as described above, and/or alkoxy groups exemplified by methoxy, ethoxy, or propoxy groups, or hydroxyl groups. In various embodiments, the organopolysiloxane or organosiloxane (a) may be represented by one of the following formulae containing silicon hydride (SiH):

R¹₃SiO(R¹₂SiO)_{d}(R¹HSiO)ₑSiR¹₃, (1)

R¹₂HSiO(R¹₂SiO)_{f}SiHR¹₂, or (2)

combinations thereof.

In formulae (1) and (2), each R¹ is independently an aliphatically saturated organic group. Suitable monovalent organic groups of R¹ include, but are not limited to, alkyl groups such as methyl, ethyl, propyl, pentyl, octyl, undecyl, and octadecyl; cycloalkyl groups such as cyclopentyl and cyclohexyl; and aryl groups such as phenyl, tolyl, xylyl, benzyl, and 2-phenylethyl.

Subscript “d” typically may have a value ranging from 0 to 2000. Subscript “e” may be 0 or a positive number. Alternatively, subscript “e” may have an average value ranging from 3 to 200. Subscript “f” may be 0 or a positive number. Alternatively, subscript “f” may have an average value ranging from 0 to 500.

In various embodiments, the organopolysiloxane component (a) may be further defined as dialkylhydrogensilyl end-blocked polydialkylsiloxane, which may itself be further defined as dimethylhydrogensilyl end-blocked polydimethylsiloxane. The organopolysiloxane may be further defined as a dimethylpolysiloxane capped at both molecular terminals with dimethylhydrogensiloxy groups; a dimethylpolysiloxane capped at both molecular terminals with methylphenylhydrogensiloxy groups; a copolymer of a methylphenylsiloxane and a dimethylsiloxane capped at both molecular terminals with dimethylhydrogensiloxy groups; a copolymer of a methylhydrogensiloxane and a dimethylsiloxane capped at both molecular terminals with trimethylsiloxy groups; a copolymer of diphenylsiloxane and dimethylsiloxane, a copolymer of a methylhydrogensiloxane and a dimethylsiloxane capped at both molecular terminals with dimethylhydrogensiloxy groups; a methyl (3,3,3-trifluoropropyl) polysiloxane capped at both molecular terminals with dimethylhydrogensiloxy groups; a copolymer of a methyl (3,3,3-trifluoropropyl) siloxane and a dimethylsiloxane capped at both molecular terminals with dimethylhydrogensiloxy groups; a copolymer of a methylhydrogensiloxane and a dimethylsiloxane capped at both molecular terminals with alkoxy groups; a copolymer of a methylhydrogensiloxane, a methylphenylsiloxane, and a dimethylsiloxane capped at both molecular terminals with alkoxy groups; or an organosiloxane copolymer composed of siloxane units represented by the following formulae: (CH₃)₃SiO_{1/2}, (CH₃)₂HSiO_{1/2}, CH₃SiO_{3/2}, (CH₃)₂SiO_{2/2}, CH₃PhSiO_{2/2} and Ph₂SiO_{2/2}.

The organopolysiloxane may further include a resin such as an MQ resin including M (R^{x}₃SiO_{1/2}, R^{x}₂HSiO_{1/2}) units and Q (SiO_{4/2}) units, a TD resin including T (R^{x}SiO_{3/2} or HSiO_{3/2}) units and D (R^{x}₂SiO_{2/2} or R^{x}HSiO_{2/2}) units, an MT resin including M (R^{x}₃SiO_{1/2} or R^{x}₂HSiO_{1/2}) units and T (R^{x}SiO_{3/2} or HSiO_{3/2}) units, an MTD resin including M (R^{x}₃SiO_{1/2} or R^{x}₂HSiO_{1/2}) units, T (R^{x}SiO_{3/2} or HSiO_{3/2}) units, and D (R^{x}₂SiO_{2/2} or R^{x}HSiO_{2/2}) units, or combinations thereof.

R^{x} designates any monovalent organic group, for example but is not limited to, monovalent hydrocarbon groups and monovalent halogenated hydrocarbon groups. Monovalent hydrocarbon groups include, but are not limited to, alkyl groups such as methyl, ethyl, propyl, pentyl, octyl, undecyl, and octadecyl; cycloalkyl groups such as cyclohexyl, and aryl groups such as phenyl, tolyl, xylyl, benzyl, and 2-phenylethyl. In one embodiment, the (a) organopolysiloxane (a) is free of halogen atoms. In another embodiment, the organopolysiloxane (a) includes one or more halogen atoms.

At least one R^{x} group is an aliphatically unsaturated group such as an alkenyl group. Suitable alkenyl groups contain from 2 carbon atoms to about 6 carbon atoms and may be, but not limited to, vinyl, allyl, and hexenyl. The alkenyl groups in this component may be located at terminal, pendant (non-terminal), or both terminal and pendant positions. The remaining silicon-bonded organic groups in the alkenyl-substituted polydiorganosiloxane are independently selected from monovalent hydrocarbon and monovalent halogenated hydrocarbon groups free of aliphatic unsaturation. These groups typically contain from 1 carbon atom to about 20 carbon atoms, alternatively from 1 carbon atom to about 8 carbon atoms and are may be exemplified by, but not limited to, alkyl such as methyl, ethyl, propyl, and butyl; aryl such as phenyl; alkylaryl, arylalkyl, and heteroaryl; and halogenated alkyl such as 3,3,3-trifluoropropyl. In one embodiment, at least about 50 percent of the organic groups in the alkenyl-substituted polydiorganosiloxane are methyl. The structure of the alkenyl-substituted polydiorganosiloxane is typically linear; however, it may include some branching due to the presence of trifunctional SiH-containing siloxane units.

Other suitable R^{x} groups include, but are not limited to, acrylate functional groups such as acryloxyalkyl groups; methacrylate functional groups such as methacryloxyalkyl groups; cyanofunctional groups; monovalent hydrocarbon groups; and combinations thereof. The monovalent hydrocarbon groups may include alkyl groups such as methyl, ethyl, propyl, isopropyl, n-butyl, s-butyl, t-butyl, pentyl, neopentyl, octyl, undecyl, and octadecyl groups; cycloalkyl groups such as cyclohexyl groups; aryl groups such as phenyl, tolyl, xylyl, benzyl, and 2-phenylethyl groups; halogenated hydrocarbon groups such as 3,3,3-trifluoropropyl, 3-chloropropyl, dichiorophenyl, and 6,6,6,5,5,4,4,3,3-nonafluorohexyl groups; and combinations thereof. The cyano-functional groups may include cyanoalkyl groups such as cyanoethyl and cyanopropyl groups, and combinations thereof.

R^{x} may also include alkyloxypoly(oxyalkyene) groups such as propyloxy(polyoxyethylene), propyloxypoly(oxypropylene) and propyloxy-poly(oxypropylene)-co-poly(oxyethylene) groups, halogen substituted alkyloxypoly(oxyalkyene) groups such as perfluoropropyloxy(polyoxyethylene), perfluoropropyloxypoly(oxypropylene) and perfluoropropyloxy-poly(oxypropylene) copoly(oxyethylene) groups, alkenyloxypoly(oxyalkyene) groups such as allyloxypoly(oxyethylene), allyloxypoly(oxypropylene) and allyloxy-poly(oxypropylene) copoly(oxyethylene) groups, alkoxy groups such as methoxy, ethoxy, n-propoxy, isopropoxy, n-butoxy and ethylhexyloxy groups, aminoalkyl groups such as 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine, and 3-propylpyrrole groups, hindered aminoalkyl groups such as tetramethylpiperidinyl oxypropyl groups, epoxyalkyl groups such as 3-glycidoxypropyl, 2-(3,4,-epoxycyclohexyl)ethyl, and 5,6-epoxyhexyl groups, ester functional groups such as acetoxymethyl and benzoyloxypropyl groups, hydroxyl functional groups such as hydroxy and 2-hydroxyethyl groups, isocyanate and masked isocyanate functional groups such as 3-isocyanatopropyl, tris-3-propylisocyanurate, propyl-t-butylcarbamate, and propylethylcarbamate groups, aldehyde functional groups such as undecanal and butyraldehyde groups, anhydride functional groups such as 3-propyl succinic anhydride and 3-propyl maleic anhydride groups, carbonyl and carboxy functional groups such as 3-carboxypropyl, 2-carboxyethyl, and 10-carboxydecyl groups, functional group of carboxalkoxy, carboxamido, amidino, nitro, cyano, primary amino, secondary amino, acylamino, alkylthio, sulfoxide, sulfone, metal salts of carboxylic acids such as zinc, sodium, and potassium salts of 3-carboxypropyl and 2-carboxyethyl groups, and combinations thereof.

Building block M represents a monofunctional unit. Building block D represents a difunctional unit. Building block T representes a trifunctional unit. Building block Q represents a tetrafunctional unit. The number of building blocks (M, D, T, Q) in the component (a) may range from 1 to about 10,000, for instance 4 to 1,000. The organopolysiloxane component (a) may include an MQ, TD, MT, or MTD resin.

The organopolysiloxane component (a) may be represented by a cyclic SiH-containing siloxane ring having the general formula (3)

R^{y}HSiO_{n/n} (3)

Formula (3) above contains n atoms of silicon with n≧3 (preferably, n=3-6). Formula (3) may include R^{y}₂SiO_{n/n}, or R^{y}HSiO_{n/n}, for cyclic siloxanes, (R^{y}₂SiO)ₙ or (R^{y}HSiO)ₙ units for a part of linear siloxanes, or a combination thereof. R^{y} designates any monovalent organic group, for example, but not limited to, monovalent hydrocarbon groups and monovalent halogenated hydrocarbon groups. Monovalent hydrocarbon groups include, but are not limited to, alkyl groups such as methyl, ethyl, propyl, pentyl, octyl, undecyl, and octadecyl; cycloalkyl groups such as cyclohexyl, and aryl groups such as phenyl, tolyl, xylyl, benzyl, and 2-phenylethyl. In one embodiment, the cyclic organopolysiloxane (a) is free of halogen atoms. In another embodiment, the cyclic organopolysiloxane (a) includes one or more halogen atoms.

The polyoxyethylene component (b) may include at least 1 functional group selected from (i) unsaturated hydrocarbon, (ii) hydroxyl, (iii) silanol, and (iv) combinations of (i), (ii), and/or (iii). The amount of polyoxyethylene component (b) that needs to be added may be represented as about 1 to about 99%, in some embodiments about 5 to about 80%, and in other embodiments about 10 to about 70%. The polyoxyethylene component (b) may have the following general formula (4)

CH₂═CRCH₂O(CH₂CH₂O)ₙR¹, (4)

Subscript “n” typically may have a value ranging from 2 to 16. R and R¹ may be different from one another and are independently selected from hydrogen atom, alkyl, aryl, vinyl, allyl, or alkylallyl.

The organopolysiloxane component (a) and the polyoxyethylene component (b) react via a hydrosilylation or coupling reaction in the presence of a catalyst. The catalysts are illustrated by any metal-containing catalyst or coupling catalyst which facilitates the reaction of silicon-bonded hydrogen atoms of (a) with the unsaturated hydrocarbon group on (b). The metal-containing catalysts are illustrated by ruthenium, rhodium, palladium, osmium, iridium, platinum, and the coupling catalysts are illustrated by metal hydroxide, tris(pentafluorophenyl)borane and potassium carbonate.

The catalysts facilitating the hydrosilylation reaction may further include: chloroplatinic acid, alcohol-modified chloroplatinic acids, olefin complexes of chloroplatinic acid, complexes of chloroplatinic acid and divinyltetramethyldisiloxane, fine platinum particles adsorbed on carbon carriers, platinum supported on metal oxide carriers such as Pt(A1₂0₃), platinum black, platinum acetylacetonate, platinum(divinyltetramethyldisiloxane), platinum halides exemplified by PtC1₂, PtC1₄, Pt(CN)₂, complexes of platinum halides with unsaturated compounds exemplified by ethylene, propylene, and organovinylsiloxanes, styrenehexamethyldiplatinum, and RhC1₃(Bu₂S)₃.

The catalysts facilitating the coupling reaction between SiH and hydroxyl or silanol through dehydrogen atoms may further include the platinum catalysts described as above, and metal hydroxide catalysts such as potassium hydroxide (KOH), metal salts such as potassium carbonate (K₂CO₃), and tris(pentafluorophenyl)borane (B(C₆F₅)₃).

The amount of catalyst that is used is not narrowly limited as long as there is a sufficient amount to accelerate a reaction between the unsaturated hydrocarbon group (b) and the SiH terminated organopolysiloxane of (a) at room temperature or at temperatures above room temperature. The exact necessary amount of this catalyst will depend on the particular catalyst utilized and is not easily predictable. However, for platinum-containing catalysts the amount can be as low as one weight part of platinum for every one million weight parts of components. The catalyst can be added in an amount from about 10 to about 120 weight parts per one million parts of components, but is typically added in an amount from about 10 to about 60 weight parts per one million parts of the polyoxyethylene-organopolysiloxane copolymer having an unsaturated organic group at each molecular terminal and the SiH terminated organopolysiloxane.

The reaction may optionally include addition of a stabilizer. The stabilizer may be added in an effective amount in order to stabilize the reaction between components (a) and (b). The stabilizer may include tocopherol or other antioxidants designed to not interfere with and not inhibit the reaction of organopolysiloxane component (a) and the polyoxyethylene component (b).

The reaction may optionally include addition of a catalytic inhibitor for platinum catalysts such as triphenylphosphine (TPP), dimethyl anhydride, dimethyl fumarate, phenyl butylnol, ethynyl cyclohexanol or any other agent designed to interfere with or inhibit the action of the catalyst. The catalytic inhibitor may be dissolved in a solvent. The solvent may include, but is not limited by, tetrahydrofuran, toluene, cyclohexane, isopropanol, 3-methyl-pentanol, ethyl acetate, glyme, diglyme, 1,4-dioxane or combinations thereof.

In another embodiment, the reaction between components (a), (b), and (c) may be conducted near or in the presence of a solvent (f). The solvent may be exemplified by, but not limited to, an alcohol such as methanol, ethanol, isopropanol, butanol, or n-propanol, 3-methyl-pentanol, a ketone such as acetone, methylethyl ketone, or methyl isobutyl ketone; an aromatic hydrocarbon such as benzene, toluene, or xylene; an aliphatic hydrocarbon such as heptane, hexane, or octane; an ether such as ethyl ether, tetrahydrofuran, 1,4-dioxane; a glycol ether such as propylene glycol methyl ether, dipropylene glycol methyl ether, propylene glycol n-butyl ether, propylene glycol n-propyl ether, or ethylene glycol n-butyl ether, a halogenated hydrocarbon such as dichloromethane, 1,1,1-trichloroethane or methylene chloride, chloroform, dimethyl sulfoxide, dimethyl acetonitrile, ethyl acetate, white spirits, mineral spirits, or naphtha. The amount of solvent can be up to about 50 weight percent, but is typically from about 20 to about 50 weight percent, said weight percent being based on the total weight of components in the reaction.

The solvent used during the reaction can be subsequently removed from the resulting hydrophilic silicone gel adhesive by various known methods. The solvent may be removed by stripping the mixture at a reduced pressure of about 0.5 mm Hg to about 20 mm Hg and at a temperature of about 50° C. to about 120° C.

The reaction may further include an unsaturated reactant (g) selected from substituted and unsubstituted unsaturated organic compounds. The unsaturated reactant (g) may be represented by the general formula (5):

R(CH₂)ₙR^{z}, (5)

Subscript n may have a value greater or equal to 1. R is selected from the group exemplified by, but not limited to, vinyl, allyl, methallyl, hydroxyl, hydroxylaryl and silanol. R^{z} is selected from the group exemplified by, but not limited to, alkyl, aryl, alkoxy, cycloalkyl, epoxyalkyl, epoxycyclohexyl, acryloxylalkyl, methacryloxylalkyl, carboxylalkyl, cholroalkyl, fluoroalkyl, and aminoalkyl.

The unsaturated reactant (g) may also be an olefin, having a general formula (6):

CH₂═CR(CH₂)ₙCH₃, (6)

Subscript n may have a value greater than or equal to 3. R may be a hydrogen atom or an alkyl. The unsaturated reactant (g) may also be allyl glycidyl ether, 4-vinyl-1-cyclohexene 1,2-epoxide.

The process of claim 1 may yield a polymerizable hybrid polysiloxane or siloxane, or, more particularly, that may have one of the following formulae (7), (8), or (9):

R¹₃SiO(R¹₂SiO)_{d}(R⁴SiO_{3/2})ₛ(SiO_{4/2})ₜ(R²HSiO)_{g}(R³R²SiO)_{e-g}SiR¹₃ (7)

R¹₃SiO(R¹₂SiO)_{d}(R⁴SiO_{3/2})ₛ(SiO_{4/2})ₜ(R²HSiO_{3/2})_{g}(R³R²SiO_{3/2})_{e-g}SiR¹₃ (8)

R¹₃SiO(R¹₂SiO)_{d}(R⁴SiO_{3/2})ₛ(SiO_{4/2})ₜ(R²HSiO_{n/n})_{g}(R³R²SiO_{n/n})_{e-g}SiR¹₃. (9)

Subscript “d” typically may have a value ranging from 0 to 2000. Subscript “s” typically may have a value ranging from 0 to 200. Subscript “t” typically may have a value ranging from 0 to 200. Subscript “e” typically may be 0 or a positive number. Alternatively, subscript “e” may have an average value ranging from 3 to 200. Subscript “g” typically may have a value ranging from 2 to 200. Subscript “n” typically may be a number greater than or equal to 1. R¹, R², and R⁴ may be independently selected from hydrogen atom and aliphatically saturated organic groups. Suitable exemplary monovalent organic groups include, but are not limited to, alkyl groups such as methyl, ethyl, propyl, pentyl, octyl, undecyl, and octadecyl; cycloalkyl groups such as cyclopentyl and cyclohexyl; and aryl groups such as phenyl, tolyl, xylyl, benzyl, and 2-phenylethyl.

R³ may have the following general formulae (10) or (11):

CH₂CRCH₂O(CH₂CH₂O)ₙR¹ (10)

(CH₂)ₙR^{z}, (11)

R may be selected from the group exemplified by, but not limited to, vinyl, allyl, methallyl, hydroxyl, hydroxylaryl and silanol. R^{z} may be selected from the group exemplified by, but not limited to, alkyl, aryl, alkoxy, cycloalkyl, epoxyalkyl, epoxycyclohexyl, acryloxylalkyl, methacryloxylalkyl, carboxylalkyl, cholroalkyl, fluoroalkyl, aminoalkyl.

The polymerizable hybrid polysiloxane or siloxane may have PEO content in the range of about 1 to about 99% and in some embodiments, about 10 to about 70% by weight. The PEO chain length, the number of the CH₂CH₂O— repeating units, may typically be 4-120 in one molecule of the polymer or oligomer, preferably 4-16. The polymerizable hybrid polysiloxane or siloxane may have several kinds of molecular structures; for example, it may have PEO as the side chains on branches, octopus, dendrimer, network, or PEO on the main chains on the polysiloxane or siloxane resin containing D, M, T, and Q.

The process of claim 1 may yield a polymerizable hybrid polysiloxane or siloxane, functionalized with silicon-vinyl, that may have one of the following formulae (12), (13), or (14):

CH₂═CH(CH₂)ₘSi(CH₃)₂O(R¹₂SiO)_{d}(R⁴SiO_{3/2})ₛ(SiO_{4/2})ₜ(R³R²SiO)_{e-g}Si(CH₃)₂(CH₂)ₘCH═CH₂, or (12)

CH₂═CH(CH₂)ₘSi(CH₃)₂O(R¹₂SiO)_{d}(R⁴SiO_{3/2})ₛ(SiO_{4/2})ₜ(R³R²SiO_{3/2})_{e-g}Si(CH₃)₂(CH₂)ₘCH═CH₂, or (13)

CH₂═CH(CH₂)ₘSi(CH₃)₂O(R¹₂SiO)_{d}(R⁴SiO_{3/2})ₛ(SiO_{4/2})ₜ(R³R²SiO_{n/n})_{e-g}Si(CH₃)₂Si(CH₂)ₘCH═CH₂. (14)

Subscript “m” typically may have a value greater or equal to 0, preferably from 0 to 4. Subscript “d” typically may have a value ranging from 0 to 2000. Subscript “s” typically may have a value ranging from 0 to 200. Subscript “t” typically may have a value ranging from 0 to 200. Subscript “e” typically may be 0 or a positive number. Alternatively, subscript “e” may have an average value ranging from 3 to 200. Subscript “g” typically may have a value ranging from 2 to 200. Subscript “n” typically may be a number greater than or equal to 1. R¹, R², and R⁴ may be independently selected from hydrogen atom and aliphatically saturated organic groups. Suitable exemplary monovalent organic groups include, but are not limited to, alkyl groups such as methyl, ethyl, propyl, pentyl, octyl, undecyl, and octadecyl; cycloalkyl groups such as cyclopentyl and cyclohexyl; and aryl groups such as phenyl, tolyl, xylyl, benzyl, and 2-phenylethyl.

R³ may have the following general formulae (10) or (11):

CH₂CRCH₂O(CH₂CH₂O)ₙR¹, or (10)

(CH₂)ₙR^{z}, (11)

R may be selected from the group exemplified by, but not limited to, vinyl, allyl, methallyl, hydroxyl, hydroxylaryl and silanol. R^{z} may be selected from the group exemplified by, but not limited to, alkyl, aryl, alkoxy, cycloalkyl, epoxyalkyl, epoxycyclohexyl, acryloxylalkyl, methacryloxylalkyl, carboxylalkyl, cholroalkyl, fluoroalkyl, aminoalkyl.

Compositions prepared according to the invention can be used in various applications in the fields of medical, personal care, house care, textile, electronics, coatings, and agriculture. The compositions prepared according to the invention can be particularly useful in medical and pharmaceutical applications, and more particularly, as cushioning materials, gentle adhesives for skin, wound interface materials for nonadherent wound dressings and foam dressings, and as soft matrix for drug release.

### EXAMPLES

These examples are intended to illustrate the invention to one of ordinary skill in the art and should not be interpreted as limiting the scope of the invention set forth in the claims. All parts and percentages in the examples are on a weight basis and all measurements were indicated at about 25° C., unless indicated to the contrary.

As used herein,

“1,3-divinyltetramethyldisiloxane” was obtained from Dow Corning Corporation (Midland, Mich.) and has the chemical formula: CH₂═CHSi(CH₃)₂—O—Si(CH₃)₂CH═CH₂;

“Allyl glycidyl ether” has the chemical formula:

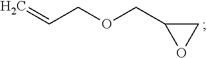

“α-olefin 6” was obtained from Chevron Phillips Chemical Company (Woodlands, Tex.) and has the chemical formula: CH₂═CH(CH₂)₃CH₃;

“α-olefin 8” was obtained from Chevron Phillips Chemical Company (Woodlands, Tex.) and has the chemical formula: CH₂═CH(CH₂)₅CH₃;

“D_{cyl-4}^{3H}D₈D_{cyl-4}^{3H}” was obtained from Dow Corning Corporation (Midland, Mich.) and has the chemical formula:

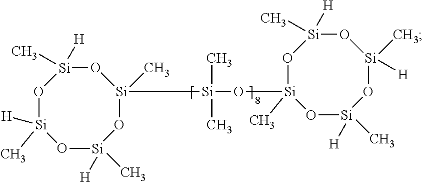

“DMUS-5” was obtained from Nippon Oil & Fats Co., Ltd. (Tokyo, Japan) and has the chemical formula: CH2═C(CH₃)CH₂O(CH₂CH₂O)₁₄CH₂(CH₃)C═CH₂;

“Karstedt's catalyst” is a Platinum-based catalyst;

“M^{H}D₁₆₉D₂₃^{H}M” was obtained from Dow Corning Corporation (Midland, Mich.) and has the chemical formula:

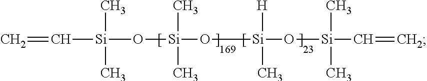

“M^{H}D₁₀₀M^{H}” was obtained from Dow Corning Corporation (Midland, Mich.) and has the chemical formula:

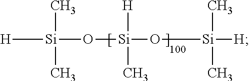

“PKA 5118” was obtained from Nippon Oil & Fats Co., Ltd. (Tokyo, Japan) and has the chemical formula: CH₂═CHCH₂O(CH₂CH₂O)₁₆CH₃;

“Platinum (IV) catalyst” is Speier's catalyst, H₂PtCl₆ into isopropanol;

“Q_{4.4}D^{H}₈” was obtained from Dow Corning Corporation (Midland, Mich.) and has the chemical formula:

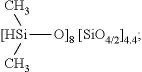

“Siloxane concentrate” is a mixture of

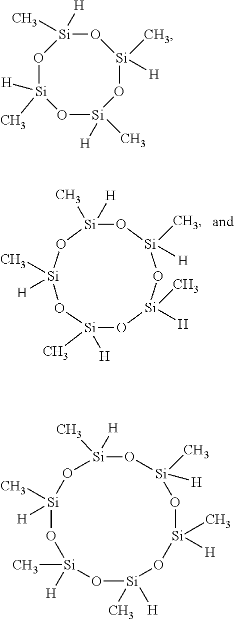 [SMILES: C[SiH]1O[SiH](C)O[SiH](C)O[SiH](C)O1 ; C[SiH]1O[SiH](C)O[SiH](C)O[SiH](C)O[SiH](C)O1 ; C[SiH]1O[SiH](C)O[SiH](C)O[SiH](C)O[SiH](C)O[SiH](C)O1]

all of which were obtained from Dow Corning Corporation (Midland, Mich.);

“THF (ACS grade)” is commercial grade tetrahydrofuran;

“Tocopherol 95” was obtained from Royal DSM N.V. (Heerlen, Netherlands);

“TPP” is triphenylphosphine;

“UNIOX™ MA 500” (hereafter, MA 500) was obtained from Nippon Oil & Fats Co., Ltd. (Tokyo, Japan) and has the chemical formula: CH₂═CHCH₂O(CH₂CH₂O)₁₁CH₃.

### Example 1

### Preparation of SiH-Containing Silicone-EO Copolymer with PEO Grafted on Silicone Chain

To a 500 mL 3-neck flask with a reflux condenser and thermometer, 30.1 g MA-500 (0.0542 mol allyl CH₂═CHCH₂—), Karstedt's catalyst (15-20 ppm), Tocopherol 95 (130˜200 ppm), 2.25 g α-olefin 8 (0.0201 mol CH₂═CH—) and 106 g THF were added to form a cloudy solution. 54.78 g (0.0898 mol SiH) of MD₁₆₉D₂₃^{H}M was then added to the flask. This cloudy mixture was allowed to react for 4 hours at refluxing temperature (70° C.) to form into one semi-transparent solution. 4-5 ppm of TPP in THF solution was added, and the reaction mixture was changed from cloudy colorless into semi-clear. The product was obtained by stripping the mixture at a reduced pressure at 75° C. to remove THF and other volatile chemicals. A cloudy liquid was collected to form into a clear, colorless liquid at room temperature; the yield was 80.3 g (92.1%). The synthesized sample had a molecular structure of the reactive SiH-containing silicone-EO copolymer and contained, on average, 4.0 SiH groups, 13.9 (EO)₁₁ groups, and 5.1 —(CH₂)₇CH₃ segments on each molecule. The synthesized sample had hydride (H) content of 0.0179% and EO content of 30.5 wt %.

### Example 2

### Preparation of SiH-Containing Silicone-EO Copolymer with PEO Grafted on Silicone Chain

To a 500 mL 3-neck flask with a reflux condenser and thermometer, 30.4 g MA-500 (0.0547 mol allyl CH₂═CHCH₂—), Karstedt's catalyst (15-20 ppm), Tocopherol 95 (130˜200 ppm), 1.71 g α-olefin 6 (CH₂═CH(CH₂)₃CH₃ (0.0203 mol CH₂═CH—) and 98 g THF were added to form a cloudy solution. 55.3 g (0.0907 mol SiH) of MD₁₆₉D₂₃^{H}M was then added to the flask. This cloudy mixture was allowed to react for 4 hours at refluxing temperature (70° C.) to form into one semi-transparent solution. 4-5 ppm of TPP in THF solution was added, and the reaction mixture was changed from cloudy colorless into semi-clear. The product was obtained by stripping the mixture at a reduced pressure at 75° C. to remove THF and other volatile chemicals. A cloudy liquid was collected to form into a clear, colorless liquid at room temperature; the yield was 79.5 g (90.9%). The synthesized sample had a molecular structure of the reactive SiH containing silicone-EO copolymer and contained, on average, 4.0 SiH groups, 13.9 (EO)₁₁ groups, and 5.1 —(CH₂)₅CH₃ segments on each molecule. The synthesized sample had hydride (H) content of 0.0179% and EO content of 30.8 wt %.

### Example 3

### Preparation of SiH-Containing Silicone-EO Copolymer with PEO Grafted on Silicone Chain

To a 500 mL 3-neck flask with a reflux condenser and thermometer, 30.83 g MA-500 (0.0554 mol allyl CH₂═CHCH₂—), Karstedt's catalyst (15-20 ppm), Tocopherol 95 (130˜200 ppm), 8.04 g allyl glycidyl ether (0.0704 mol CH₂═CHCH₂O—), and 122 g THF were added to form a cloudy solution. 93.8 g (0.154 mol SiH) of MD₁₆₉D₂₃^{H}M was then added to the flask. This cloudy mixture was allowed to react for 4 hours at refluxing temperature (72° C.) to form into one cloudy solution. 4-5 ppm of TPP in THF solution was added, and the reaction mixture was changed from cloudy colorless into semi-clear. The product was obtained by stripping the mixture at a reduced pressure at 80° C. to remove THF and other volatile chemicals. A cloudy liquid was collected to form into a cloudy, white, viscous liquid at room temperature; the yield was 121.5 g (91.5%). The synthesized sample had a molecular structure of the reactive SiH-containing silicone-EO copolymer and contained, on average, 4.2 SiH groups, 8.3 (EO)₁₁ groups, and 10.5 glycidyl groups on each molecule. The synthesized sample had hydride (H) content of 0.0210% and EO content of 24.1 wt %.

### Example 4

### Preparation of SiH-Containing Silicone-EO Copolymer with PEO Grafted on Silicone Chain

To a 500 mL 3-neck flask with a reflux condenser and thermometer, 8.39 g MA-500 (0.0151 mol allyl CH₂═CHCH₂—), Karstedt's catalyst (15-20 ppm), Tocopherol 95 (130˜200 ppm), 12.64 g allyl glycidyl ether (0.111 mol CH₂═CHCH₂— groups) and 116 g THF were added to form a cloudy solution. 97.65 g (0.160 mol SiH) of MD₁₆₉D₂₃^{H}M was then added to the flask. This cloudy mixture was allowed to react for 4 hours at refluxing temperature (72° C.) to form into one clear solution. 4-5 ppm of TPP in THF solution was added, and the reaction mixture kept colorless and clear. The product was obtained by stripping the mixture at a reduced pressure at 76° C. to remove THF and other volatile chemicals. A cloudy liquid was collected to form into a cloudy, white, viscous liquid at room temperature; the yield was 110.2 g (93.9%). The synthesized sample had a molecular structure of the reactive SiH-containing silicone-EO copolymer and contained, on average, 5 SiH groups, 2.1 (EO)₁₁ groups, and 15.9 glycidyl groups on each molecule. The synthesized sample had hydride (H) content of 0.0289% and EO content of 14.3 wt %.

### Example 5

### Preparation of SiH-Containing Silicone-EO Copolymer with Light Crosslinked Network

To a 500 mL 3-neck flask with a reflux condenser and thermometer, 31.43 g MA-500 (0.056 mol allyl CH₂═CHCH₂—), 0.42 g DMUS-5 (0.0011 mol methallyl CH₂═C(CH₃)CH₂—), Karstedt's catalyst (15-20 ppm), Tocopherol 95 (130˜200 ppm), and 62 g THF were added to form a cloudy solution. 43.06 g (0.0706 mol SiH) MD₁₆₉D₂₃^{H}M was then added to the flask. This cloudy mixture was allowed to react for 4 hours at refluxing temperature (75° C.) to form into one semi-transparent solution. 4-5 ppm of TPP in THF solution was added, and the reaction mixture was changed from cloudy colorless into clear. The product was obtained by stripping the mixture at a reduced pressure at 75° C. to remove THF and other volatile chemicals. A viscous, white, unclear liquid was collected; the yield was 71.5 g (95.5%). The synthesized sample was a reactive silicone-EO network-like copolymer and contained, on average, 4.2 SiH groups and 18.4 (EO)₁₁ groups crosslinked with 0.37 (EO)₁₄ groups on each molecule, with hydride (H) content of 0.0172% and EO content of 35.3 wt %.

### Example 6

### Preparation of SiH-Containing Silicone-EO Copolymer with Light Crosslinked Network

To a 500 mL 3-neck flask with a reflux condenser and thermometer, 31.86 g MA-500 (0.057 mol allyl group, CH₂═CHCH₂—), 1.31 g DMUS-5 (0.0035 mol methallyl group, CH₂═C(CH₃)CH₂—), Karstedt's catalyst (15-20 ppm), Tocopherol 95 (130˜200 ppm), and 62 g THF were added to form a cloudy solution. 43.7 g (0.072 mol SiH) MD₁₆₉D₂₃^{H}M was then added to the flask. This cloudy mixture was allowed to react for 4 hours at refluxing temperature (75° C.) to form into one semi-transparent solution. 4-5 ppm of TPP in THF solution was added, and the reaction mixture was changed from cloudy colorless into clear. The product was obtained by stripping the mixture at a reduced pressure at 75° C. to remove THF and other volatile chemicals. A viscous, white, unclear liquid was collected; the yield was 72.4 g (94.2%). The synthesized sample was a reactive silicone-EO network-like copolymer that contained, on average, 3.4 SiH groups and 18.4 (EO)₁₁ groups crosslinked with 1.13 (EO)₁₄ groups on each molecule, with hydride (H) content of 0.014% and EO content of 35.8 wt %.

### Example 7

### Preparation of SiH-Containing Silicone-EO Copolymer with PEO on Cyclic Silicone Molecules

To a 500 mL 3-neck flask with a reflux condenser and thermometer, 75.9 g DMUS-5 (0.2045 mol methallyl CH₂═C(CH₃)CH₂—), Karstedt's catalyst (15-20 ppm), Tocopherol 95 (130˜200 ppm), and 49.4 g cyclohexane (CHx) were added to form a clear solution. 42.86 g (0.714 mol SiH) of the siloxane concentrate with 4.5 SiH groups on average per molecule was then added to the flask. This cloudy mixture was allowed to react for 4 hours at refluxing temperature (75° C.) to form into one transparent solution. 4-5 ppm of TPP in CHx solution was added. The product was obtained by stripping the mixture at a reduced pressure at 75° C. to remove CHx and other volatile chemicals. A clear, colorless, viscous liquid was collected; the yield was 110.2 g (92.8%). The synthesized sample was a reactive silicone-EO octopus copolymer that contained, on average, 3.2 SiH groups and 1.3 (EO)₁₁ groups on each molecule, with hydride (H) content of 0.43% and EO content of 53.0 wt %.

### Example 8

### Preparation of SiH-Containing Silicone-EO Copolymer with PEO on Cyclic Silicone Molecules

To a 500 mL 3-neck flask with a reflux condenser and thermometer, 44.9 g MA-500 (0.0801 mol allyl CH₂═CHCH₂—), Karstedt's catalyst (15-20 ppm), Tocopherol 95 (130˜200 ppm), and 82.3 g THF were added to form a clear solution. 12.2 g (0.203 mol SiH) of the siloxane concentrate with 4.5 SiH groups on average per molecule was then added to the flask. This cloudy mixture was allowed to react for 4 hours at refluxing temperature (75° C.) to form into one transparent solution. 4-5 ppm of TPP in THF solution was added. The product was obtained by stripping the mixture at a reduced pressure at 75° C. to remove THF and other volatile chemicals. A white, cloudy, viscous liquid was collected; the yield was 52.5 g (93.7%). The synthesized sample was a reactive silicone-EO cyclic copolymer that contained, on average, 2.7 SiH groups and 1.8 (EO)₁₁ groups on each cyclic molecule, with hydride (H) content of 0.215% and EO content of 18.5 wt %.

### Example 9

### Preparation of SiH-Containing Silicone-EO Copolymer with PEO on Octopus Silicone Molecules

To a 500 mL 3-neck flask with a reflux condenser and thermometer, 43.6 g MA-500 (0.078 mol allyl CH₂═CHCH₂—), Karstedt's catalyst (15-20 ppm), Tocopherol 95 (130˜200 ppm), and 58 g THF were added to form a cloudy solution. 31.1 g (0.124 mol SiH) of D_{cyl-4}^{3H}D₈D_{cyl-4}^{3H} was then added to the flask. This cloudy mixture was allowed to react for 4 hours at refluxing temperature (75° C.) to form into one semi-transparent solution. 4-5 ppm of TPP in THF solution was added, and the reaction mixture was changed from cloudy colorless into clear. The product was obtained by stripping the mixture at a reduced pressure at 75° C. to remove THF and other volatile chemicals. A clear, colorless, low viscous liquid was collected; the yield was 72 g (96%). The synthesized sample was a reactive silicone-EO octopus copolymer that contained, on average, 3.8 SiH groups and 2.2 (EO)₁₁ groups on each molecule, with hydride (H) content of 0.0617% and EO content of 48.5 wt %.

### Example 10

### Preparation of SiH-Containing Silicone-EO Copolymer with PEO on Octopus Silicone Molecules

To a 1 L 3-neck flask with a reflux condenser and thermometer, 98.44 g MA-500 (0.177 mol allyl CH₂═CHCH₂—), 15.46 g PKA 5118 (0.020 mol allyl CH₂═CHCH₂—), Karstedt's catalyst (15-20 ppm), Tocopherol 95 (130˜200 ppm), and 93.5 g THF were added to form a cloudy solution. 146.9 g (0.588 mol SiH) of D_{cyl-4}^{3H}D₈D_{cyl-4}^{3H} was then added to the flask. This cloudy mixture was allowed to react for 4 hours at refluxing temperature (75° C.) to form into one non-transparent solution. 4-5 ppm of TPP in THF solution was added, and the reaction mixture was changed from cloudy colorless into clear. The product was obtained by stripping the mixture at a reduced pressure at 75° C. to remove THF and other volatile chemicals. A white, cloudy, viscous liquid was collected; the yield was 245.8 g (94%). The synthesized sample was a reactive silicone-EO octopus copolymer that contained, on average, 4.0 SiH groups and 1.8 (EO)₁₁ groups, and 0.2 (EO)₁₆ groups on each molecule, with hydride (H) content of 0.150% and EO content of 36.5 wt %

### Example 11

### Preparation of SiH-Containing Silicone-EO Copolymer with Light Crosslinked Network

To a 500 mL 3-neck flask with a reflux condenser and thermometer, 35.1 g MA-500 (0.063 mol allyl CH₂═CHCH₂—), 0.58 g DMUS-5 (0.00156 mol methallyl CH₂═C(CH₃)CH₂—), Karstedt's catalyst (15-20 ppm), Tocopherol 95 (130˜200 ppm), and 46 g THF were added to form a cloudy solution. 25.1 g (0.100 mol SiH) of D_{cyl-4}^{3H}D₈D_{cyl-4}^{3H} was then added to the flask. This cloudy mixture was allowed to react for 4 hours at refluxing temperature (75° C.) to form into one semi-transparent solution. 4-5 ppm of TPP in THF solution was added, and the reaction mixture was changed from cloudy colorless into clear. The product was obtained by stripping the mixture at a reduced pressure at 75° C. to remove THF and other volatile chemicals. A clear, colorless, low viscous liquid was collected; the yield was 56 g (96%). The synthesized sample was a reactive silicone-EO network-like copolymer that contained, on average, 3.9 SiH groups and 2.1 (EO)₁₁ groups on each molecule, with hydride (H) content of 0.0585% and EO content of 48.8 wt %.

### Example 12

### Preparation of SiH-Containing Silicone-EO Copolymer with PEO on Silicone Resin Chain

To a 1 L 3-neck flask with a reflux condenser and thermometer, 100.9 g MA-500 (0.182 mol allyl CH₂═CHCH₂—), Karstedt's catalyst (15-20 ppm), Tocopherol 95 (130˜200 ppm), and 91 g THF were added to form a cloudy solution. 30.3 g (0.291 mol SiH) of Q_{4.4}D^{H}₈ liquid was then added to the flask. This cloudy mixture was allowed to react for 4 hours at refluxing temperature (76° C.) to form into one transparent solution. 4-5 ppm of TPP in THF solution was added, and the reaction mixture was changed from cloudy colorless into clear. The product was obtained by stripping the mixture at a reduced pressure at 114° C. to remove THF and other volatile chemicals. A clear, colorless, low viscous liquid was collected; the yield was 128 g (96.2%). The synthesized sample was a reactive silicone-EO network-like copolymer that contained, on average, 3 SiH groups and 5 (EO)₁₁ groups on each molecule, with hydride (H) content of 0.0837% and EO content of 63.9 wt %.

### Example 13

### Preparation of SiH-Containing Silicone-EO Copolymer with PEO on Silicone Resin Chain

SiH-containing silicone-EO copolymer with PEO on silicone chain was synthesized in a similar method to example 12 above, but instead, by reaction of 31.31 g MA-500 (0.056 mol allyl CH₂═CHCH₂—) with 103.51 g Q_{4.4}D^{H}₈ (0.995 mol SiH) liquid. The synthesized sample was a cloudy, viscous liquid. The synthesized sample was a reactive silicone-EO copolymer that contained, on average, 7.5 SiH groups and 0.5 (EO)₁₁ groups on each molecule, with hydride (H) content of 0.696% and EO content of 19.3 wt %.

### Example 14

### Preparation of Hydrophilic Polyether-Siloxane Copolymers with Functional Silicon-Vinyl (SiVi)

To a 1 L 3-neck flask with a reflux condenser and thermometer, 30.6 g of DMUS-5 (0.083 mol methallyl CH₂═C(CH₃)CH₂—), Platinum (IV) catalyst (15-20 ppm), Tocopherol 95 (130˜200 ppm), and 175 g THF were added to form a cloudy solution. 362.2 g (0.094 mol SiH) of M^{H}D₁₀₀M^{H} was then added to the flask. This cloudy mixture was allowed to react for 4 hours at refluxing temperature (77° C.) to form semi-transparent solution. 3.62 g (0.039 mol silicone vinyl) of 1,3-divinyltetramethyldisiloxane was added to keep this reaction for another 2 hours. 4-5 ppm of TPP in THF solution was added. Typically, the reaction mixture was changed from cloudy colorless into semi-clear. The product was obtained by stripping the mixture at a reduced pressure at 110° C. to remove THF and other volatile chemicals. A hazy liquid with a middle viscosity was collected; the yield was 381 g (96.2%). The synthesized sample had a molecular structure of α,ω-vinyl linear Si-PEO copolymer, M^{Vi}[D₁₀₂-CH₂CH₂(CH₃)CH₂O-(EO)₁₄]₇M^{Vi} and had a vinly(Vi) content of 0.081% and EO content of 6.2 wt %.

### Example 15

### Preparation of Hydrophilic Polyether-Siloxane Copolymers with Functional Silicon-Vinyl (SiVi)

Hydrophilic polyether-siloxane copolymers with functional silicon-vinyl (SiVi) had a major component with a molecular structure of α,ω-vinyl linear siloxane-EO copolymer, M^{Vi}[D₁₉-CH₂CH₂(CH₃)CH₂O-(EO)₁₄]₄M^{Vi} and a Vi content of 0.51%, EO content of 22.2 wt %.

### Example 16

### Preparation of Hydrophilic Polyether-Siloxane Copolymers with Functional Silicon-Vinyl (SiVi)

Hydrophilic polyethersiloxane copolymers with functional silicon-vinyl (SiVi) with a molecular structure of α,ω-vinyl linear Si-PEO copolymer, M^{Vi}[D₁₉-CH₂CH₂CH(CH₃)CH₂O-(EO)₁₆]_{23.7}M^{Vi} and a Vi content of 0.098%, EO content of 26.4 wt %.

While the invention is susceptible to various modifications and alternative forms, specific embodiments have been shown by way of example in the examples and described in detail herein. It should be understood, however, that the invention is not intended to be limited to the particular forms disclosed. Rather, the invention is to cover all modifications, equivalents, and alternatives falling within the spirit and scope of the invention as defined by the appended claims.

1. A process of making a polymerizable hybrid siloxane or polysiloxane comprising reacting:
a) an organopolysiloxane or an organosiloxane having an average of at least 3 silicon hydride (SiH) groups per molecule;
b) a polyoxyethylene;
c) a catalyst;
d) optionally, a stabilizer;
e) optionally, a catalytic inhibitor;
f) optionally, a solvent; and
g) optionally, an unsaturated reactant selected from substituted and unsubstituted unsaturated organic compounds.

2. The process of claim 1, wherein the organopolysiloxane or organosiloxane includes one or more terminal groups selected from alkyl, aryl, alkoxy, and hydroxyl groups.

3. The process of claim 1, wherein the organopolysiloxane is characterized by a general formula:
R¹₃SiO(R¹₂SiO)_{d}(R¹HSiO)ₑSiR¹₃, or (1)
R¹₂HSiO(R¹₂SiO)_{f}SiHR¹₂, (2)
wherein d is 0-2000; e is 3-200; f is 0-500; and each R¹ is independently selected from aliphatically saturated organic groups.

4. The process of claim 3, wherein R¹ is a monovalent organic alkyl, cycloalkyl, or aryl group.

5. The process of claim 1, wherein the organopolysiloxane includes a cyclic siloxane ring having a general formula:
R^{y}HSiO_{n/n}, (3)
wherein n≧3; and R^{y} is a monovalent organic group.

6. The process of claim 1, wherein the organopolysiloxane comprises a resin, wherein the resin is an MQ, TD, MT, or MTD resin, wherein
M is R^{x}₃SiO_{1/2} or R^{x}₂HSiO_{1/2}
D is R^{x}₂SiO_{2/2} or R^{x}HSiO_{2/2};
T is R^{x}SiO_{3/2} or HSiO_{3/2}; and
Q is SiO_{4/2},
wherein R^{x} is a monovalent organic group.

7. The process of claim 1, wherein the polyoxyethylene comprises at least 1 functional group selected from:
(i) unsaturated hydrocarbon;
(ii) hydroxyl;
(iii) silanol; and
(iv) any combination of (i), (ii), or (iii).

8. The process of claim 1, wherein the polyoxyethylene has a general formula:
CH₂═CRCH₂O(CH₂CH₂O)ₙR¹, (4)
wherein n=2-16; and R and R¹ are independently selected from hydrogen atom, alkyl, aryl, vinyl, allyl, or alkylallyl.

9. The process of claim 1, wherein the catalyst is a metal-containing catalyst selected from platinum, rhodium, ruthenium, palladium, osmium, and iridium, or a coupling catalyst selected from tris(pentafluorophenyl)borane and potassium carbonate.

10. The process of claim 1, wherein the stabilizer is tocopherol.

11. The process of claim 1, wherein the unsaturated reactant has a general formula:
R(CH₂)ₙR^{z}, (5)
wherein n≧1; R is vinyl, allyl, methallyl, hydroxyl, hydroxylaryl, or silanol, and R^{z} is alkyl, aryl, alkoxy, cycloalkyl, epoxyalkyl, epoxycyclohexyl, acryloxylalkyl, methacryloxylalkyl, carboxylalkyl, cholroalkyl, fluoroalkyl, or aminoalkyl.

12. The process of claim 1, wherein the unsaturated reactant is an olefin that has a general formula:
CH₂═CR(CH₂)ₙCH₃, (6)
wherein n≧3; and R is hydrogen atom or alkyl.

13. The process of claim 1, further comprising stripping a resulting mixture at a reduced pressure.

14. A polymerizable hybrid polysiloxane or siloxane, having a general formula:
R¹₃SiO(R¹₂SiO)_{d}(R⁴SiO_{3/2})ₛ(SiO_{4/2})ₜ(R²HSiO)_{g}(R³R²SiO)_{e-g}SiR¹₃, or (7)
R¹₃SiO(R¹₂SiO)_{d}(R⁴SiO_{3/2})ₛ(SiO_{4/2})ₜ(R²HSiO_{3/2})_{g}(R³R²SiO_{3/2})_{e-g}SiR¹₃, or (8)
R¹₃SiO(R¹₂SiO)_{d}(R⁴SiO_{3/2})ₛ(SiO_{4/2})ₜ(R²HSiO_{n/n})_{g}(R³R²SiO_{n/n})_{e-g}SiR¹₃, (9)
wherein d is 0-2000; s is 0-200; t is 0-200; e is 3-200; g is 2-200; n≧1; R¹, R², and R⁴ are independently selected from hydrogen atom or monovalent organic groups; and R³ has a general formula:
CH₂CRCH₂O(CH₂CH₂O)R¹, or (10)
(CH₂)ₙR^{z}, (11)
wherein R is vinyl, allyl, methallyl, hydroxyl, hydroxylaryl, or silanol; and R^{z} is alkyl, aryl, alkoxy, cycloalkyl, epoxyalkyl, epoxycyclohexyl, acryloxylalkyl, methacryloxylalkyl, carboxylalkyl, cholroalkyl, fluoroalkyl, or aminoalkyl.

15. A polymerizable hybrid polysiloxane or siloxane, having a general formula:
CH₂═CH(CH₂)ₘSi(CH₃)₂O(R¹₂SiO)_{d}(R⁴SiO_{3/2})ₛ(SiO_{4/2})ₜ(R³R²SiO)_{e-g}Si(CH₃)₂(CH₂)ₘCH═CH₂, or (12)
CH₂═CH(CH₂)ₘSi(CH₃)₂O(R¹₂SiO)_{d}(R⁴SiO_{3/2})ₛ(SiO_{4/2})ₜ(R³R²SiO_{3/2})_{e-g}Si(CH₃)₂(CH₂)ₘCH═CH₂, or (13)
CH₂═CH(CH₂)ₘSi(CH₃)₂O(R¹₂SiO)_{d}(R⁴SiO_{3/2})ₛ(SiO_{4/2})ₜ(R³R²SiO_{n/n})_{e-g}Si(CH₃)₂Si(CH₂)ₘCH═CH₂, (14)
wherein m is 0-4; d is 0-2000; s is 0-200; t is 0-200; e is 3-200; g is 2-200; n≧1; R¹, R², and R⁴ are independently selected from hydrogen atom or monovalent organic groups; and R³ has a general formula:
CH₂CRCH₂O(CH₂CH₂O)R¹, or (15)
(CH₂)ₙR^{z}, (16)
wherein R is vinyl, allyl, methallyl, hydroxyl, hydroxylaryl, or silanol; and R^{z} is alkyl, aryl, alkoxy, cycloalkyl, epoxyalkyl, epoxycyclohexyl, acryloxylalkyl, methacryloxylalkyl, carboxylalkyl, cholroalkyl, fluoroalkyl, or aminoalkyl.

16. The process of claim 5, wherein R^{y} is an alkyl group, cycloalkyl group, or aryl group.

17. The process of claim 6, wherein R^{x} is an alkyl group, cycloalkyl group, or aryl group.

18. The process of claim 1, wherein the catalytic inhibitor is triphenylphosphine and, optionally.

19. The process of claim 1, wherein the solvent is tetrahydrofuran, toluene, cyclohexane, isopropane, ethyl acetate, or any combination thereof.

20. The process of claim 1, wherein the unsaturated reactant is an allyl glycidyl ether.
